(19) United States
(12) Patent Application Publication
(10) Pub. No.: US 2015/0131606 A1
(43) Pub. Date: May 14, 2015

(54) RADIO BASE STATION AND RADIO COMMUNICATION SYSTEM

(71) Applicant: FUJITSU LIMITED, Kawasaki-shi (JP)

(72) Inventors: Kazuya Kobayashi, KAWASAKI (JP); Shunsuke IIZUKA, Kawasaki (JP); Seiji Hamada, Kawasaki (JP)

(21) Appl. No.: 14/495,457

(22) Filed: Sep. 24, 2014

(30) Foreign Application Priority Data
Nov. 12, 2013 (JP) 2013-234293

(51) Int. Cl. H04W 36/00; H04L 5/00; H04W 72/04

(52) U.S. Cl. CPC H04W 36/0072; H04W 72/0413; H04L 5/001; H04L 5/0051
USPC 370/330; 370/331

(57) ABSTRACT

An allocation of radio resources in one of first and second radio areas in which a fading frequency estimated value with a relatively low estimation accuracy is obtained is controlled based on a fading frequency estimated value with a relatively high estimation accuracy among the fading frequency estimated values obtained from a radio signal sent by the radio terminal and received in the first and second radio areas.

### CROSS-REFERENCE TO RELATED APPLICATION

This application is based upon and claims the benefit of priority of the prior Japanese Patent Application No. 2013-234293, filed on Nov. 12, 2013, the entire contents of which are incorporated herein by reference.

### FIELD

The embodiment discussed herein is related to a radio base station and a radio communication system.

### BACKGROUND

According to International Publication No. 2010/140347 (hereinafter, referred to as “Patent Document 1”), in the 3GPP (3rd Generation Partnership Project), an LTE-A (LTE-Advanced) has been discussed as a next generation communication method of LTE (Long Term Evolution). The LTE-A aims at achieving a higher speed communication than that of LTE, and is demanded to support a wider band than that of LTE (for example, a band up to 100 MHz exceeding a band of 20 MHz of LTE).

Hence, a technology referred to as a carrier aggregation (CA) which can achieve a high speed and large capacity communication is proposed by the 3GPP. According to the CA, a communication is performed by using aggregated multiple carriers, each of which has a bandwidth up to 20 MHz, for the purpose of maintaining compatibility (backward compatibility) with the LTE as much as possible. Consequently, it is possible to secure a bandwidth of 100 MHz at maximum. In the CA, an aggregated carrier with bandwidth up to 20 MHz may be referred to as a component carrier (CC).

According to the technology disclosed in Patent Document 1, upon starting data transmission or changing a CC used to transmit data to a terminal apparatus, a base station apparatus determines a CC used to transmit data based on each radio quality of a plurality of CCs, and notifies the terminal apparatus of the determined CC. According to this technology, even when the CA which aggregates a plurality of carriers is applied to a communication, it is possible to prevent consumption power from increasing and prevent communication efficiency from lowering upon changing a CC used for a communication.

As an example of a radio communication technology which uses the CA, an arrangement to arrange, in a first communication area of a first radio base station, one or more of second radio base stations and to form a second communication area which is, for example, narrower than the first communication area by the second radio base station(s) is discussed.

The first communication area is referred to as, for example, a macrocell (or a macro coverage), and the second communication area is referred to as, for example, a small cell (or a small coverage). Different frequencies can be used between the macrocell and the small cell. For example, the frequency used in the small cell is higher than the frequency used in the macrocell.

The second radio base station which forms the small cell may also be referred to as a RRH (Remote Radio Head). By contrast with this, the first radio base station which forms the macrocell may also be referred to as a BTS (Base Transceiver Station) or an eNB (evolved Node B). The RRH is, for example, arranged at a spot (also referred to as a hot spot.) at which traffic concentrates or arranged at a dead zone of the macrocell. Consequently, the RRH is possible to absorb the traffic at the hot spot or to complement the dead zone of the macrocell.

In environment in which a small cell is provided in an overlay arrangement with respect to the macrocell as described above, a radio terminal positioned in a small cell is available to access both of the small cell (RRH) and the macrocell (BTS).

In such environment, when the radio terminal moves in the small cell, a difference between: a change in the distance between the radio terminal and one of the BTS and the RRH; and a change in a distance between the radio terminal and the other one of the BTS and the RRH may be occurred.

This difference influences a fading frequency estimation accuracy estimated based on a signal received from the radio terminal. Therefore, when a communication with the radio terminal is controlled using a fading frequency estimated value, communication quality (for example, a throughput in an uplink) with respect to the radio terminal may deteriorates in some cases.

Patent Document 1 merely discloses a technology of determining a CC used to transmit data based on radio quality of each CC and notifying a terminal apparatus of the determined CC, and fails to disclose or suggest an influence on communication control when the above-described difference between changes in distances is occurred.

### SUMMARY

According to one aspect of a radio base station, the radio base station is configured to process a radio signal received from a radio terminal configured to perform a communication using radio resources of a first radio area and a second radio area. The radio station includes a controller configured to control an allocation of a radio resource in one of the first and second radio areas in which a fading frequency estimated value with a relatively low estimation accuracy is obtained, by using a fading frequency estimated value with a relatively high estimation accuracy among the fading frequency estimated values obtained from a radio signal sent by the radio terminal and received in the first and second radio areas.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a radio communication system;

FIG. 2 is a diagram explaining an example of communication control in the radio communication system illustrated in FIG. 1;

FIG. 3 is a diagram explaining a case where a fading frequency estimation accuracy deteriorates in the radio communication system illustrated in FIG. 1;

FIG. 4 is a diagram explaining that a reception timing of a signal deviates in accordance with a movement of a radio terminal in the radio communication system illustrated in FIG. 1;

FIG. 5 is a diagram explaining that a fading frequency estimation accuracy deteriorates due to the timing deviation illustrated in FIG. 4;

FIG. 6 is a diagram illustrating that a fading frequency estimated value is notified from a macrocell to a small cell in the radio communication system according to an embodiment;

FIG. 7 is a diagram illustrating an example of a processing sequence in the radio communication system illustrated in FIG. 6;

FIG. 8 is a sequence diagram illustrating an example of processing of requesting and reporting a fading frequency estimated value in the radio communication system illustrated in FIG. 6;

FIG. 9 is a flowchart explaining processing of detection a timing deterioration which influences the fading frequency estimation accuracy in the radio communication system illustrated in FIG. 6;

FIG. 10 is a diagram illustrating an example of a delay profile obtained by the timing detection processing illustrated in FIG. 9;

FIG. 11 is a diagram illustrating an example of a relationship between a SRS period, a synchronization timer and a synchronization period in the radio communication system illustrated in FIG. 6;

FIG. 12 is a flowchart illustrating an example of processing of reporting a fading frequency estimation result in the radio communication system illustrated in FIG. 6;

FIG. 13 is a diagram illustrating an example of an estimated value management table held in a radio base station illustrated in FIG. 6;

FIG. 14 is a flowchart explaining utilization processing of a fading frequency estimation result at a request-source in the radio communication system illustrated in FIG. 6;

FIG. 15 is a flowchart illustrating an example of processing of calculating a fading frequency illustrated in FIG. 14;

FIG. 16 is a functional block diagram illustrating a configuration example of the radio base station illustrated in FIG. 6;

FIG. 17 is a block diagram illustrating an example of a configuration focusing on a signal processor illustrated in FIG. 16;

FIG. 18 is a diagram illustrating an example of a hardware configuration of the radio base station illustrated in FIG. 6;

FIG. 19 is a diagram illustrating an example of a radio communication system according to a first modified example of the embodiment;

FIG. 20 is a diagram illustrating that a fading frequency estimation accuracy deteriorates due to a timing deviation in the radio communication system illustrated in FIG. 19; and

FIGS. 21 and 22 are diagrams illustrating an example of a radio communication system according to a second modified example of the embodiment.

### DESCRIPTION OF EMBODIMENTS

An embodiment of the present invention will be described below with reference to the drawings. However, the embodiment described below is only exemplary and is not intended to exclude various modifications and an application of a technique which are not described below. In addition, in the drawings used in the following embodiment, components assigned the same reference numerals represent the identical or same components unless specified in particular.

(Outline)

After LTE release 10 (LTE Rel.10), a CA which supports RRHs in uplink (UL) is discussed as deployment scenario 4. For example, this is a case indicated by #4 in 3GPP TS 36.300 v10.3.0 Annex J (informative): Carrier Aggregation J.1 Deployment Scenarios.

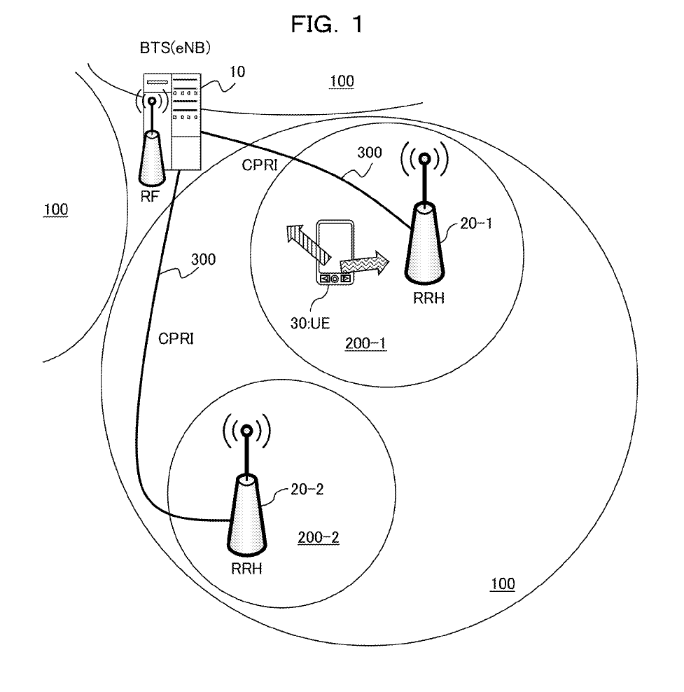

In this regard, as illustrated in FIG. 1 for example, a case where one or more of small cells 200-1 and 200-2 is provided in an macrocell 100 with an overlay arrangement is assumed. In this case, a radio terminal 30 positioned in the small cell 200-1 is, for example, available to access both of the macrocell 100 (BTS 10) and the small cell 200-1 (RRH 20-1). The radio terminal 30 may also be referred to as a UE (User Equipment) or a MS (Mobile Station).

The macrocell 100 is an example of a first radio area formed by the BTS 10. The first radio area may also be referred to as a primary cell (Pcell). The BTS 10 may also be referred to as an eNB 10. The small cells 200-1 and 200-2 are examples of second radio areas formed by the RRH 20-1 and 20-2, respectively. The second radio area may also be referred to as a secondary cell (Scell). A relationship between the first radio cell and the second radio area may also be reversed.

When the RRHs 20-1 and 20-2 are not necessary to be distinguished from each other, the RRHs 20-1 and 20-2 may generically be referred to as the “RRH 20”. Further, when the small cells (or Scells) 200-1 and 200-2 are not necessary to be distinguished from each other, the small cells 200-1 and 200-2 may generically be referred to as the “small cell 200” or the “Scell 200”.

A name of each cell does not matter as long as there is a relationship that the Scells are provided in the Pcell with an overlay arrangement. The name of a cell may be, for example, a macrocell, a femtocell, a picocell or a microcell. A femtocell, a picocell and a microcell may be collectively referred to as small cells.

The eNB 10 and the RRH 20 are communicably connected by using a wired transmission path 300, for example. The wired transmission path 300 is, for example, an optical fiber transmission path and may also be referred to as a CPRI (Common Public Radio Interface). However, the eNB 10 and the RRHs 20 may be communicable connected by radio transmission paths. The eNB 10 and the RRH 20 may be considered as individual radio base stations or may be considered to form a single radio base station.

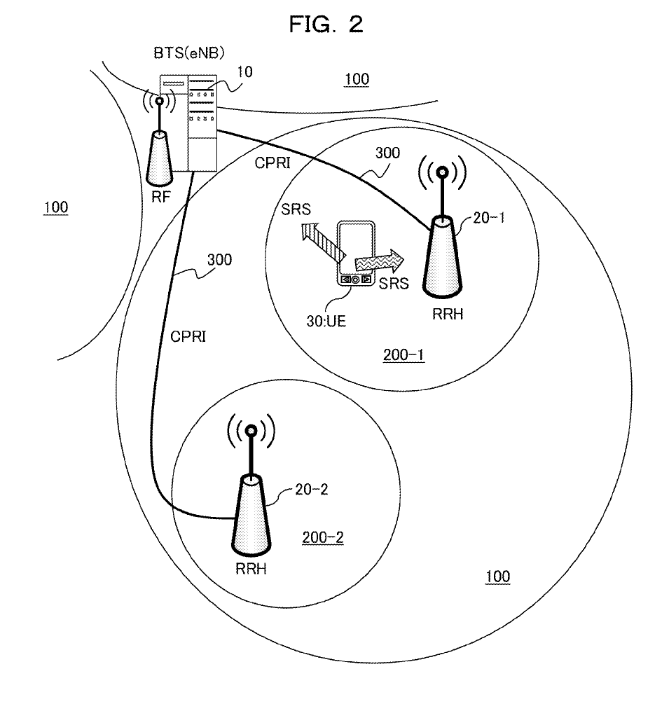

By the way, according to an example of radio communication control in a UL in the LTE, a radio base station controls a UL communication by using a known signal (for example, a reference signal such as a sounding reference signal, SRS) transmitted from the UE 30 as illustrated in FIG. 2.

For example, the radio base station is operable to estimate a fading frequency based on a received SRS, to control (or schedule) an allocation of resources (for example, a band) used by the radio terminal 30 for transmission, and to change reception processing (for example, a demodulation scheme) of a UL signal.

Even after LTE release 10, the above UL control is assumed to be performed in the eNB and the RRH using the SRS in view of the backward compatibility with LTE release 8. However, after LTE release 10, until resynchronization is established after synchronization between a radio base station and a radio terminal is established, a fading frequency estimation accuracy deteriorates in some cases due to, for example, a timing deviation in accordance with a movement of the radio terminal. When the fading frequency estimation accuracy deteriorates, the above UL control using the SRS is influenced and a UL reception throughput deteriorates.

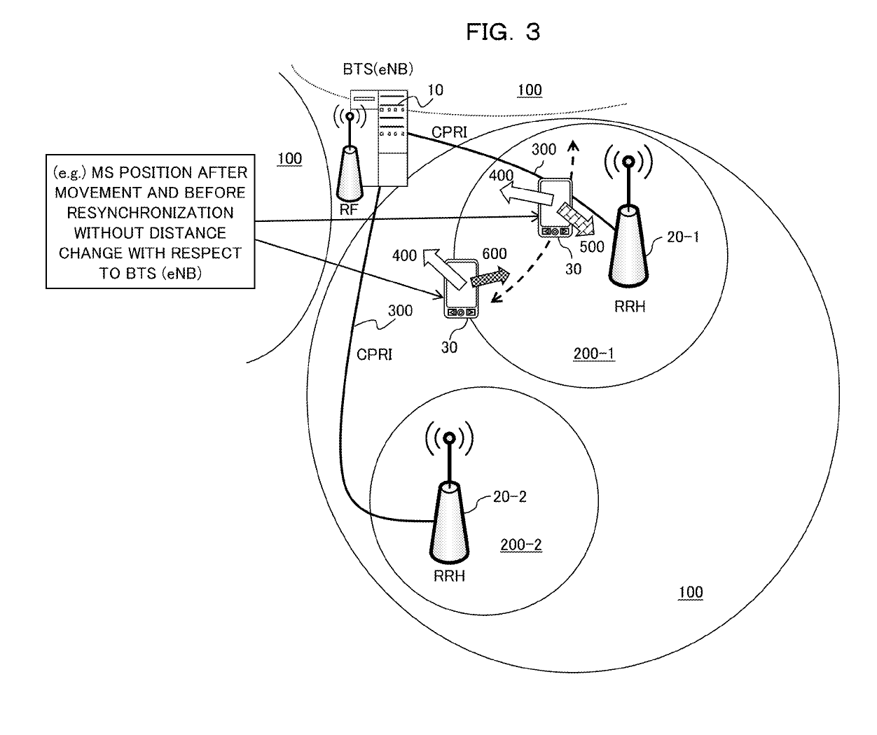

FIG. 3 illustrates an example of a case where a fading frequency estimation accuracy deteriorates. It is assumed that, when the UE 30 establishes synchronization with, for example, the eNB 10 and the RRH 20-1 and performs a communication by using resources of both of the macrocell 100 and the small cell 200-1, the UE 30 moves along a circle having the eNB 10 as the center in the small cell 200-1.

In this case, although a distance to the UE 30 does not seem to change from a view point of the eNB 10 which forms the macrocell 100, the UE 30 moves away from the RRH 20-1 from the view point of the RRH 20-1 which forms the small cell 200-1, and therefore, the distance to the UE 30 changes.

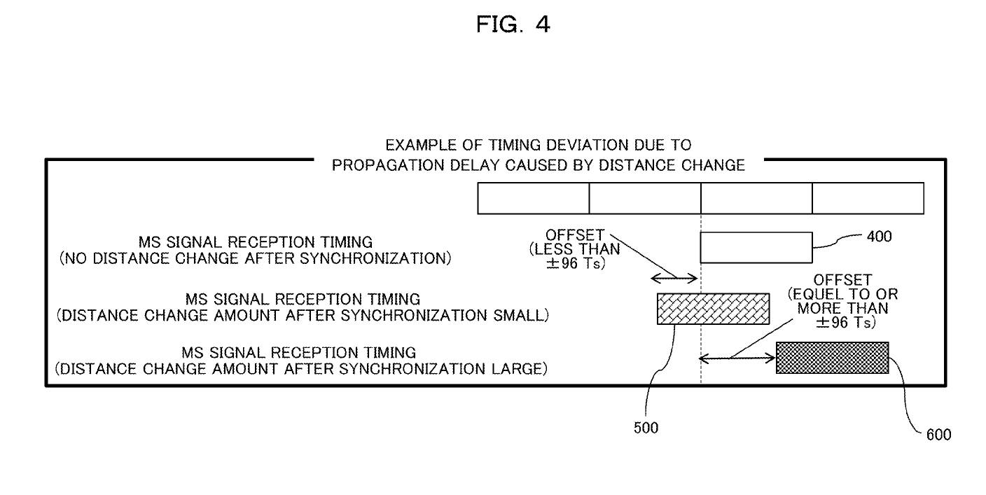

Hence, a propagation delay of the SRS received at the eNB 10 does not change or is minimum as indicated by, for example, reference numerals 400 in FIGS. 3 and 4. Therefore, a SRS reception timing in the eNB 10 does not deviate or deviates at minimum from a reference timing after establishment of synchronization. In contrast, a propagation delay of the SRS received at the RRH 20-1 becomes significant according to the change in the distance to the UE 30 as indicated by reference numeral 600 in FIGS. 3 and 4. Therefore, a SRS reception timing in the RRH 20-1 deviates from the reference timing after establishment of synchronization. Reference numeral 500 depicted in FIGS. 3 and 4 indicates an example where the UE 30 approaches the RRH 20-1 a little after establishment of synchronization (the change in the distance is small compared to the case indicated by reference numeral 600) and an example that the SRS reaches the RRH 20-1 earlier than the reference timing.

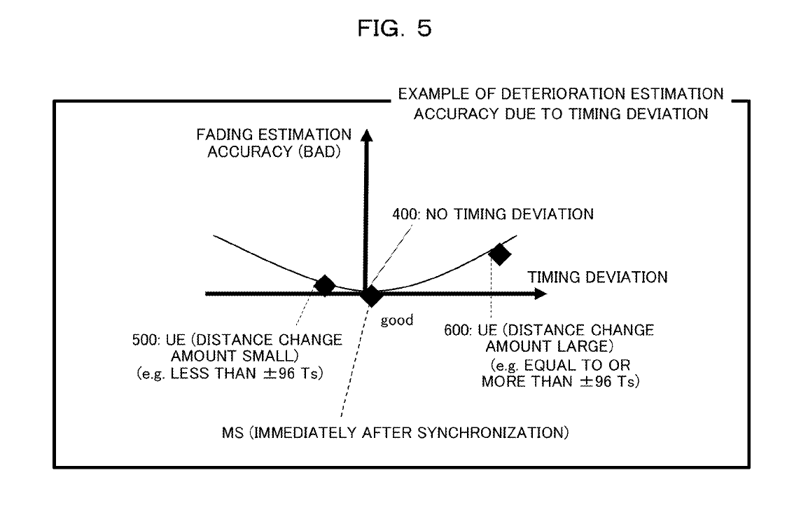

Such a deviation in a SRS reception timing (hereinafter, may also be referred to simply as a “timing deviation”) may cause deterioration of a fading frequency estimation accuracy. As illustrated in FIG. 5 for example, a quadric deterioration may be occurred in a fading frequency estimation accuracy in accordance with the timing deviation. Therefore, when the timing deviation is equal to or a predetermined value, the fading frequency estimation accuracy may significantly deteriorate. A nonrestrictive example of the predetermined value is ±96 Ts (Ts represents a sampling time and is, for example, 32.6 ns).

Hence, in the case indicated by reference numeral 500 in FIGS. 3 and 4, since the timing deviation is less than ±96 Ts, an influence on the fading frequency estimation accuracy is limited and may be ignored. However, in the case indicated by reference numeral 600 in FIGS. 3 and 4, since the timing deviation is equal to or more than ±96 Ts, an unignorable deterioration is occurred in the fading frequency estimation accuracy. Therefore, a UL reception throughput of the RRH 20-1 deteriorates.

Contrary to the above cases, there is also a case where a UL reception throughput of the macrocell 100 (eNB 10) deteriorates. For example, this is the case where the UE 30 moves along a circle having the RRH 20-1 as the center in the small cell 20-1. In this case, although the distance to the UE 30 does not change from the view point of the RRH 20-1, the distance to the UE 30 changes from the view point of the eNB 10. Therefore, a SRS timing deviation may occur in the eNB 10 and the fading frequency estimation accuracy may deteriorate.

In this regard, the present embodiment described below achieves to prevent a UL reception throughput from decreasing due to the above-described deterioration of the fading frequency estimation accuracy. For example, a UL communication in one of cells formed by the eNB 10 and the RRH 20-1 (or 20-2) is controlled based on an estimated value of the other of cells in which the fading frequency estimation accuracy is assumed to deteriorate little. In other words, the UL communications in both of the cells are controlled based on an estimated value of the other of cells in which the fading frequency estimation accuracy is assumed to deteriorate little.

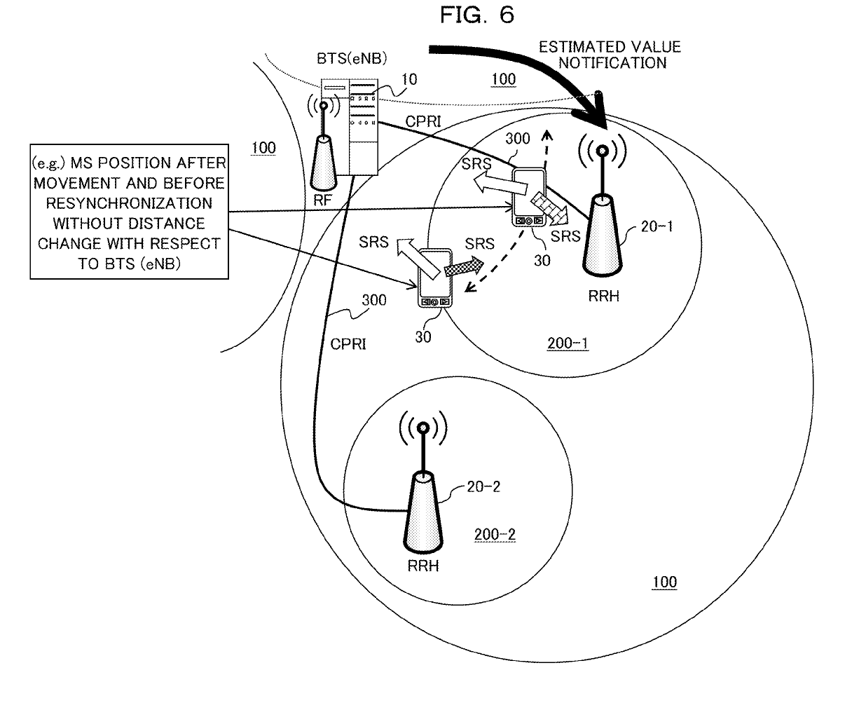

In the case illustrated in FIG. 3, the estimated value of the fading frequency of the eNB 10 is notified to the RRH 20-1 through, for example, the CPRI as illustrated in FIG. 6. Thereby, the RRH 20-1 controls a UL communication based on the notified estimated value. An example of a UL communication control may include, for example, controlling (or scheduling) an allocation of a radio resource (for example, a band) used by the UE 30 for transmission, or changing reception processing (for example, a demodulating scheme) of a UL signal. Consequently, even though the estimated value of the fading frequency in the RRH 20-1 deteriorates, it is possible to prevent the reception throughput of the RRH 20-1 from decreasing.

(Application Phase)

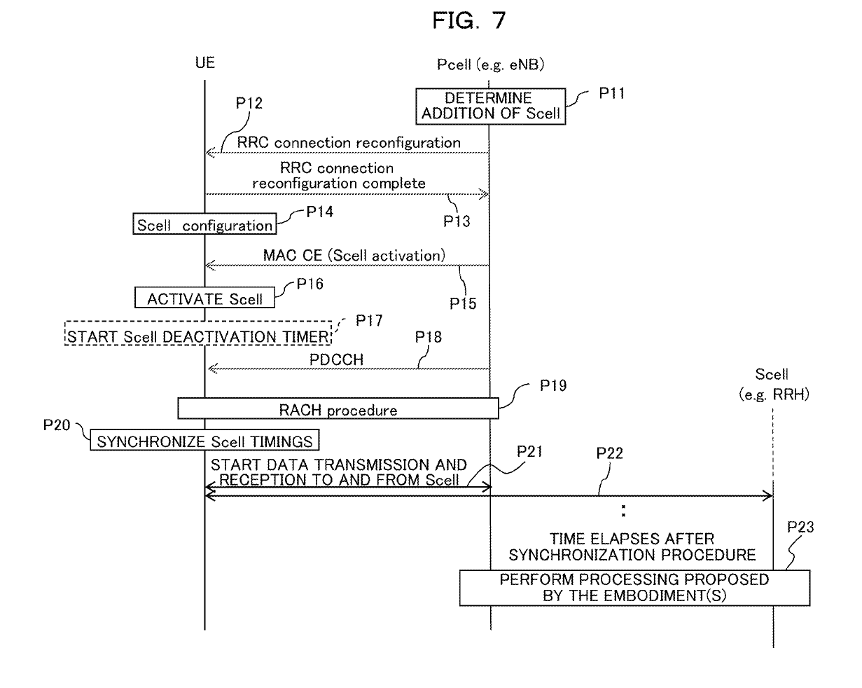

The above-described notification of the fading frequency estimated value is performed after the UE 30 establishes synchronization with the eNB 10 (Pcell) and the RRH 20 (Scell) (processing P23) as illustrated in FIG. 7, for example.

An addition, deletion or reconfiguration of Scell may be performed by providing the UE 30 with a control signal from the Pcell. For example, Upon determining the addition of a Scell (processing P11), the eNB 10 transmits an RRC (Radio resource Control) signaling to the UE 30 through a control plane (processing P12). An RRC connection reconfiguration message is applicable to the RRC signaling.

The addition of the Scell means that the CC is controlled. For example, in order to control a CC, the UE 30 periodically measures a radio quality of a serving cell or one or more neighboring cells, and transmits a measurement report (MR) to the eNB 10 when satisfying a certain condition instructed by the eNB 10. The eNB 10 determines based on the received MR whether or not to control the CC. Upon controlling the CC (for example, in a case where a Scell is added), the eNB 10 transmits the above RRC connection reconfiguration message to the UE 30 to give an instruction of the CC control to the UE 30.

Upon receiving the message, the UE 30 controls the CC, starts processing of preparing a communication with the Scell and transmits a response signal for the received RRC signaling to the eNB 10 (processing P13 and P14). An RRC connection reconfiguration complete message is applicable to the response signal.

Upon receiving the response signal from the UE 30, the eNB 10 transmits a control signal to instruct an activation of the Scell to the UE 30 (processing P15). The control signal may be transmitted by a control element of a MAC (Media Access Control) layer (MAC CE). The eNB 10 is possible to manage the Scell in the MAC layer and to activate or deactivate the Scell or to control discontinuous reception (DRX) in the Scell by using the MAC CE.

Upon receiving the MAC CE with the activation instruction of the Scell, the UE 30 activates the Scell (processing P16). The UE 30 which activates the Scell may start a timer which counts a time to deactivate the activated Scell (processing P17). Upon an expiration of the timer, the UE 30 may autonomously deactivate the Scell. The timer may also be referred to as a Scell deactivation timer. The Scell deactivation timer is disclosed in, for example, “3GPP TS 36.321 v10.5.0 Chapter 5.13”, “3GPP TS 36.331 v10.5.0 Chapter 6.3.2” and “3GPP TS 36.213 v10.5.0 Chapter 4.3”.

After the above activation instruction of the Scell is transmitted to the UE 30, the eNB10 transmits a synchronization request to the UE 30 (processing P18). The synchronization request may be transmitted to the UE 30 by using a PDCCH (Physical Downlink Control Channel) which is an example of a control channel in downlink (DL).

Upon receiving the synchronization request, the UE 30 performs random access procedure (RACH procedure) with the eNB 10 (processing P19), and establishes a synchronization with the eNB 10 (processing P20). Since the reference timings of processing in the eNB 10 and the RRH 20 are matched each other, the UE 30 is available to establish a synchronization with both of the Pcell and the Scell to communicate with both of the Pcell and the Scell (processing P20 and P21).

Subsequently, the eNB 10 may performs a synchronization procedure with the UE 30 periodically. A period for performing the synchronization procedure may also be referred to as a synchronization period. In any one of synchronization periods, one of the Pcell and the Scell notifies a fading frequency estimated value to the other one (processing P23).

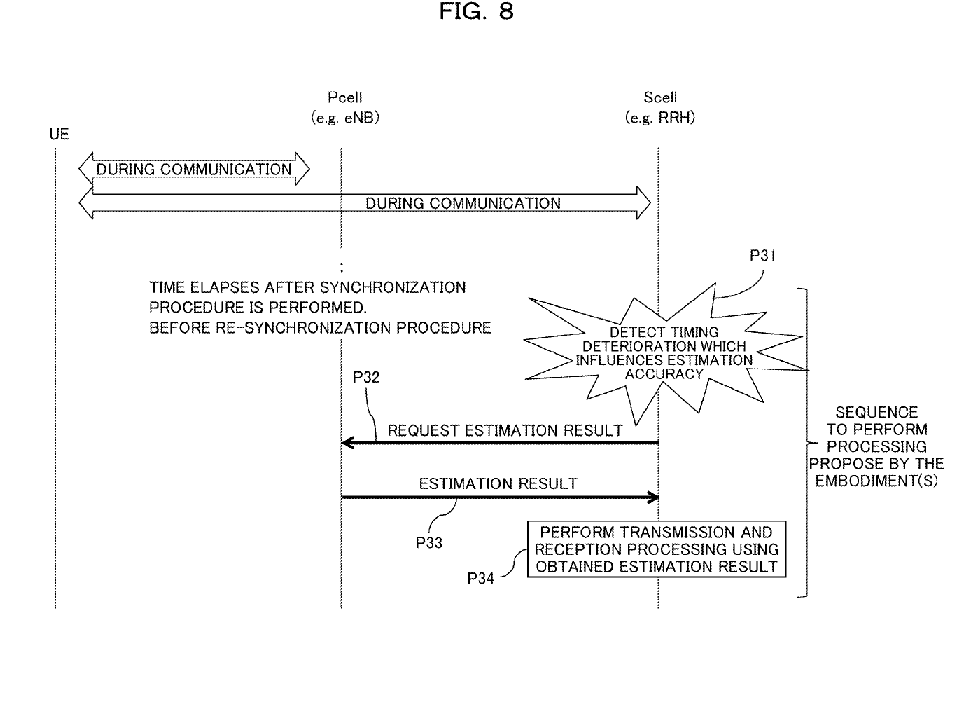

For example, as illustrated in FIG. 8, after the synchronization procedure is performed and before resynchronization procedure is performed, a timing deviation which influences a fading frequency estimation accuracy is detected in the Scell (RRH 20) (processing P31).

Upon a detection of the timing deviation, the RRH transmits an estimation result request to the eNB 10 through, for example, the CPRI 300 to obtain the fading frequency estimated value from the eNB 10 (Pcell) (processing P32).

Upon a reception of the estimation result request, the eNB 10 transmits a fading frequency estimation result in the Pcell to the request-source RRH 20 (processing P33).

The RRH 20 controls a communication with the UE 30 in the Scell by using the estimation result received from the eNB 10 (processing P34).

(Example of Timing Deviation Detection Processing).

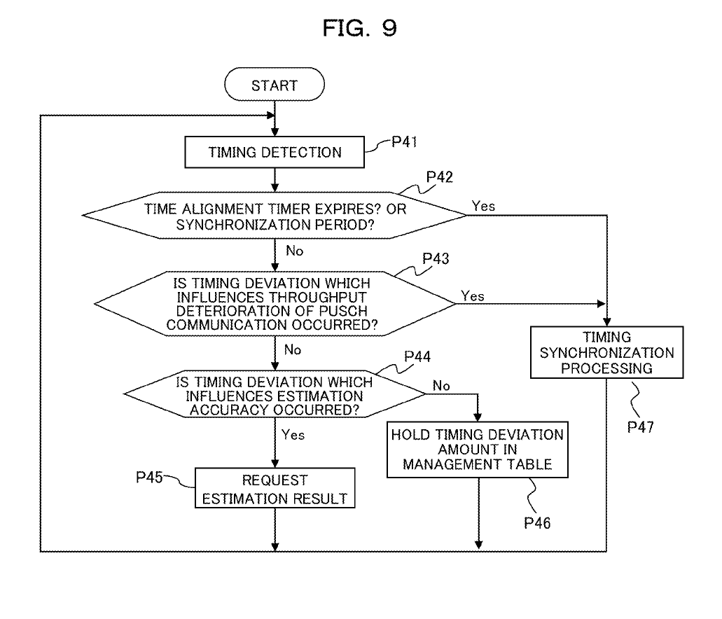

Next, FIG. 9 illustrates an example of processing of detecting a timing deviation which influences a fading frequency estimation accuracy in above processing P31. For example, the RRH 20 is operable to obtain a delay profile based on a correlation value between a received signal (an SRS as a non-limited example) from the UE 30 and a correction detection code (reference signal), and to detect a difference from the originally desired reference timing based on the delay profile (processing P41).

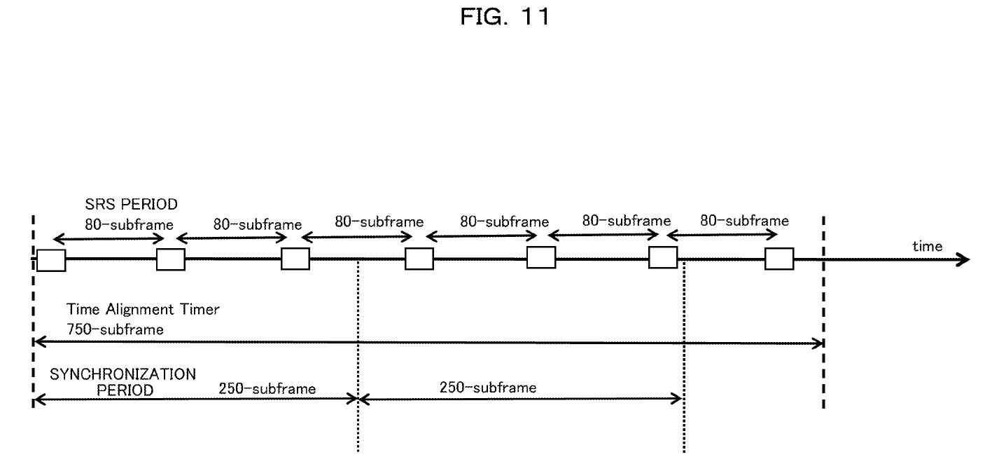

A SRS transmission period is, for example, “2 to 320 subframes”+“offset in period”. The SRS transmission period is disclosed in, for example, “3GPP TS 36.213 Chapter 8.2”, and “AN INTRODUCTION TO LTE Chapter 8.7.2 (written by Christopher Cox, WILEY)”. As a non-limited example, an SRS is transmitted every 80-subframe as illustrated in FIG. 11, for example. One subframe is, for example, 1 ms. Hence, the SRS is transmitted at an 80 ms period in the example in FIG. 11.

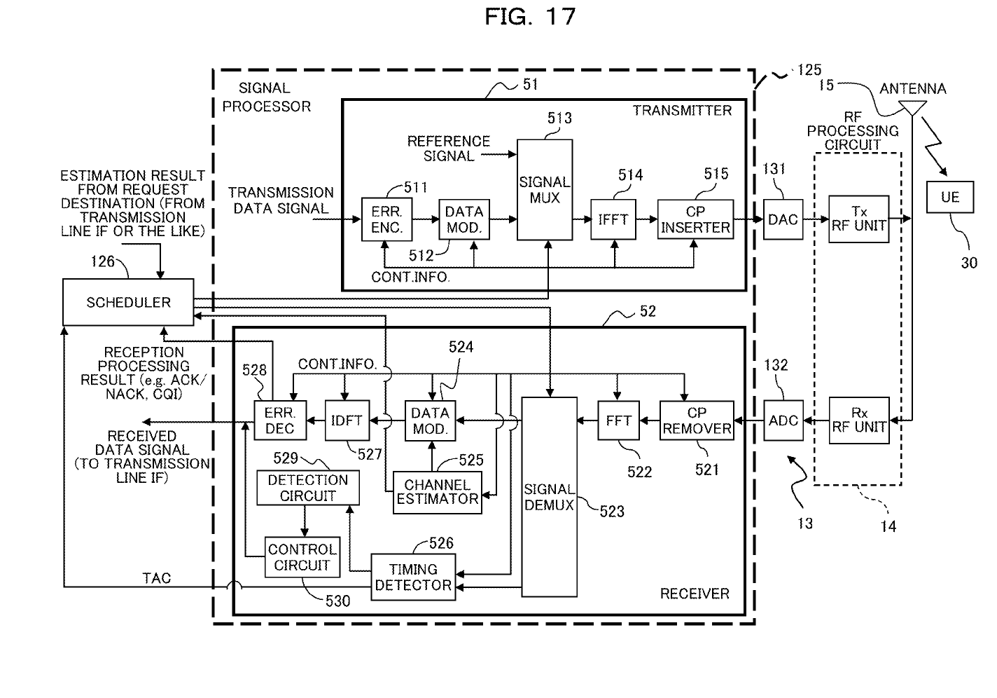

The RRH 20 extracts subcarriers on which the SRS is mapped, from the received signal expanded in the frequency domain by using, for example, fast Fourier transform (FFT) processing (hereinafter, may be referred to as a subcarrier demapping). Next, the RRH 20 multiplies the demapped signal with a complex conjugate of a reference signal (RS) sequence to obtain as the correlation value a signal obtained by canceling a reference signal sequence from the received signal. The above processing is performed by a signal demultiplexer 523 described below with reference to FIG. 17, for example.

Further, the RRH 20 transforms the correlation value in the frequency domain into a correlation value in a time domain by performing, for example, inverse fast Fourier transform (IFFT) on the obtained correction value. In this regard, signals from a plurality of UEs 30 can be multiplexed in each band of a SRS by cyclic-shift-multiplexing. Hence, time domain signal data obtained by the IFFT processing is data in which signal waveforms received from each of the UEs 30 and subjected to cyclic-shift-multiplexing based on the same RS sequence periodically appears in the time domain.

For example, when a cyclic shift number of each UE 30 is nₛᵣₛ, a cyclic shift amount α of the SRS can be expressed by the following expression (1).

α=2π(nₛᵣₛ/8) (1)

In this case, a phase just rotates 360 degrees at eight cyclic shifts. Hence, a signal from each UE 30 appears in each domain obtained by dividing by eight the data after the IFFT processing. Therefore, the RRH 20 calculates a domain including the signal received from the UE 30, from a periodic waveform detected in the time domain based on the cyclic shift number of each UE 30, and extracts the domain (hereinafter, may be referred to as a cyclic shift removal). The cyclic shift is disclosed in, for example, “3GPP TS 36.211 Chapter 5.5.3.1”.

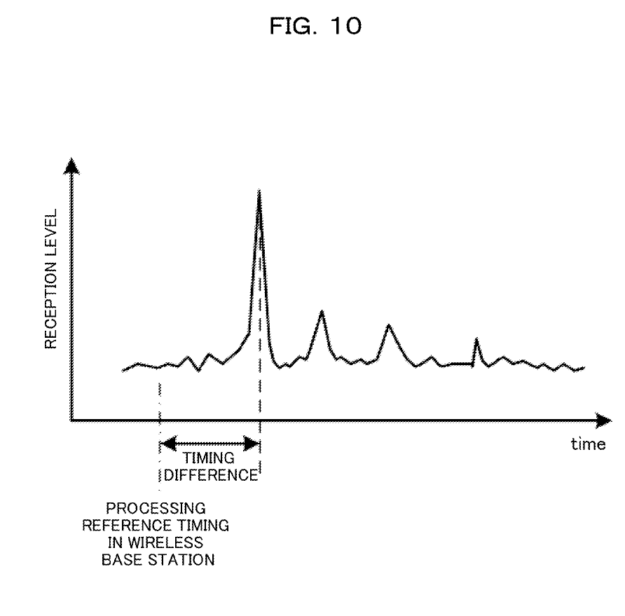

Further, the RRH 20 converts the signal extracted for each UE 30 into power by squaring the signal. Thereby, a delay profile representing received power (or reception level) with respect to the time as illustrated in, for example, FIG. 10 is obtained. The RRH 20 detects a timing at which the reception power of the obtained delay profile comes to a peak, and calculates a difference (or a timing deviation) between the timing and the originally desired reference timing (or the processing reference timing of the RRH 20). The above processing is performed by a timing detector 526 and an estimation accuracy deterioration timing detection circuit 529 described later with reference to FIG. 17, for example.

The obtained timing deviation is information used for a timing advance (TA) value to adjust a transmission timing of a UL signal. The RRH 20 is available to control the transmission timing of the UE 30 based on that information. A signal used for this control is, for example, a signal referred to as a TA command (Timing Advance Command). The TA command may be transmitted to the UE 30 as control information of a MAC layer (MAC CE). A method of generating the TA command from the detected timing deviation is disclosed in, for example, “3GPP TS 36.213 Chapter 4.2.3”.

Turning back to FIG. 9, after detecting the timing deviation as described above, the RRH 20 checks whether or not a synchronization timer referred to as a TAT (Time Alignment Timer) expires or a current timing corresponds to a timing of a synchronization period (processing P42).

The synchronization timer checks whether or not the UL signal reception timing of the RRH 20 settles in a predetermined window while keeping a transmission timing setting of a current UL signal. In other words, the synchronization timer counts a time period during which a synchronization of a UL signal can be guaranteed. Upon detecting of an expiration of the synchronization timer, the UE 30 recognizes that the synchronization with the eNB 10 or the RRH 20 is lost and does not transmit a UL signal.

When one subframe is 1 ms, for example, the synchronization timer is set to one of values in a range of 500 to 10240 subframes (that is, a range of 0.5 to 10.24 seconds). In an example in FIG. 11, the synchronization timer (TAT) is set to 750 subframes. The synchronization timer is disclosed in, for example, “3GPP TS 36.331v10.5.0 Chapter 6.3.2”, “3GPP TS 36.321v10.5.0 Chapter 5.2” and “AN INTRODUCTION TO LTE Chapter 10.1.2 (written by Christopher Cox, WILEY)”.

Further, it may be understood that the synchronization period corresponds to a period for periodically updating the above-described TA value and transmitting the TA command to the UE 30. In the example in FIG. 11, the synchronization period is set to 250 subframes. The UE 30 fails to receive a new TA value by the TA command, the UE 30 recognizes that the synchronization with the eNB 10 or the RRH 20 is lost and does not transmit a UL signal. The synchronization period is disclosed in, for example, “AN INTRODUCTION TO LTE Chapter 10.1.2” and “JP 2011-503959 A”. Further, with respect to the above-described relationship between a SRS transmission period and a synchronization period of a synchronization timer (TAT), “3GPP TS 36.211v10.5.0 Chapter 5.5.3.3”, “3GPP 36.213v10.5.0 Chapter 8.2” and “AN INTRODUCTION TO LTE Chapter 8.7.2” are helpful.

When the synchronization timer (TAT) does not expire and when the current timing is not a timing of a synchronization timing (No in processing P42), the RRH 20 determines whether or not the timing deviation detected in processing P41 influences deterioration of a throughput for a UL communication (processing P43). The UL communication in this case refers to a communication which uses, for example, a PUSCH (Physical Uplink Shared Channel) which is an example of a UL data channel.

The timing deviation which influences deterioration of a throughput for a UL communication corresponds to a timing deviation which, when a timing deviation exceeding this timing deviation occurs, makes it difficult to maintain synchronization for a UL communication and substantially lowers a throughput, for example. For example, when a channel bandwidth of the PUSCH is 5 MHz and a normal CP (cyclic prefix) is used, the timing deviation which influences deterioration of a throughput for a UL communication corresponds to a timing deviation exceeding 144 Ts. The normal CP is used in a case (type 1) where seven OFDM (Orthogonal Frequency Division Multiplexing) symbols are mapped on one slot (=0.5 ms), for example. Two slots (1 ms) form one subframe, and ten subframes form one radio frame (10 ms).

Upon determining that the detected timing deviation does not influence the deterioration of the throughput for a UL communication as a result of determination in processing P43 (No in processing P43), the RRH 20 further determines whether or not this timing deviation influences a fading frequency estimation accuracy (processing P44). In this regard, when a channel bandwidth of a PUSCH is 5 MHz and the normal CP is used, for example, the timing deviation which influences a fading frequency estimation accuracy corresponds to a timing deviation in a range of about 96 Ts to 144 Ts. Hence, a timing deviation less than 96 Ts may be determined as a timing deviation which does not influence a fading frequency estimation accuracy.

Upon determining that the detected timing deviation influences the fading frequency estimation accuracy as a result of the above determination (Yes in processing P44), the RRH 20 requests an estimation result to the Pcell (eNB 10) as described above with reference to FIG. 8 (processing P45 (processing P32 in FIG. 8). The request may include, for example, identification information for identifying the UE 30 in which a timing deviation that influences a fading frequency estimation accuracy is occurred.

Upon determining that the detected timing deviation is not a timing deviation which influences a fading frequency estimation accuracy in processing P44, the RRH 20 records (or holds), for example, the timing deviation (amount) detected in processing P41 in a timing management table (not illustrated) (Processing P46 from No route in processing P44). Information held in the timing management table may be provided to other eNBs or RRHs if necessary.

Further, when it is determined as Yes in processing P42 or processing P43, the RRH 20 performs the timing synchronization procedure (processing P47). That is, when the synchronization timer (TAT) expires, when the current timing is a timing of a synchronization period or when it is determined that the detected timing deviation influences deterioration of a throughput for a UL communication, the timing synchronization procedure is performed. The timing synchronization procedure includes, for example, performing random access procedure (RACH procedure) and updating a transmission timing adjusted value (TA) (transmitting a TA command).

For example, after performing the random access procedure (RACH procedure) as described above and establishing synchronization, the UE 30 updates the TA and establishes a timing synchronization by receiving TA commands at regular intervals from the eNB 10 as illustrated in FIG. 11. However, when the synchronization timer (TAT) expires while the UE 30 fails to receive a TA command and to update the timing synchronization, the eNB 10 recognizes that the timing synchronization with the UE 30 is lost.

In this case, the eNB 10 releases radio resources allocated to the UE 30, and a random access procedure is triggered to establish a resynchronization. Radio resources to be released are, for example, resources of a UL control channel (for example, PUCCH) and a UL data channel (for example, PUSCH). The PUCCH is an abbreviation of a Physical Uplink Control Channel.

(Example of Estimation Result Report Processing)

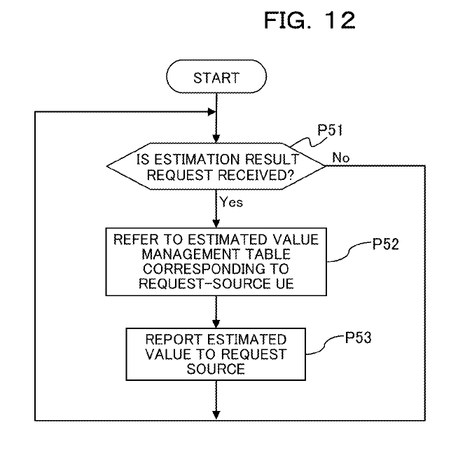

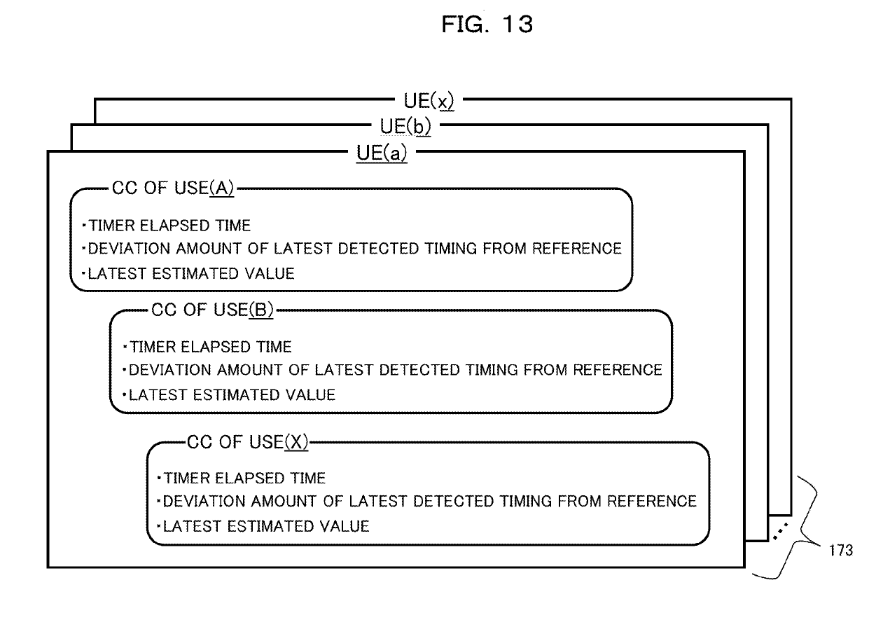

Next, a processing example in the eNB 10 when the eNB 10 receives the above fading frequency estimation result request will be described with reference to FIGS. 12 and 13.

As illustrated in FIG. 12, the eNB 10 monitors whether or not the eNB 10 receives the estimation result request from the RRH 20 (No route in processing P51). Upon detecting the estimation result request from the RRH 20 (Yes in processing P51), the eNB 10 refers to an estimated value management table 173 illustrated in FIG. 13 (processing P52).

The estimated value management table 173 is configured to manage, for each UE 30 and for each CC used by the UE 30, an elapsed time (timer elapsed time) after an establishment of synchronization, a deviation amount of the latest detected timing from the reference timing and an estimated value obtained on the basis of this timing deviation amount.

The eNB 10 searches in the estimated value management table 173 based on identification information of the UE 30 included in the estimation result request from the RRH 20, and selects and transmits (or reports) an optimal estimated value to the request-source RRH 20 (processing P53 in FIG. 12). For example, the eNB 10 selects a minimum estimated value of the timing deviation amount in the estimated value management table 173. When there is a plurality of estimated values of the same timing deviation amount, an estimated value of a shorter time elapsed after establishment of synchronization is selected.

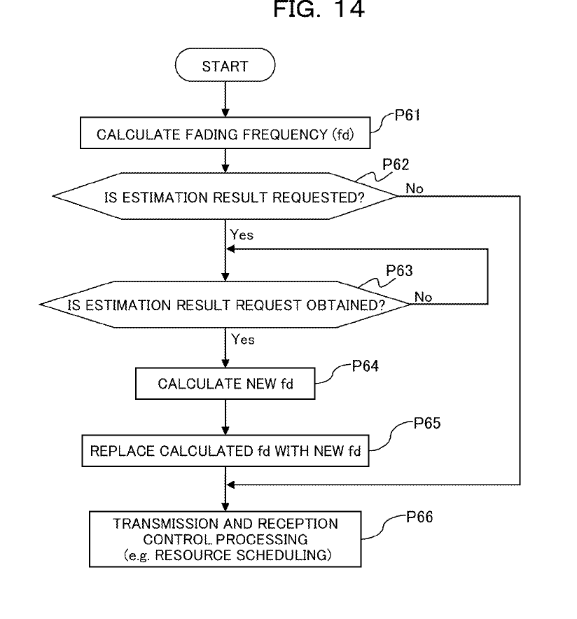

In addition, the eNB 10 may also report a frequency of a CC used to calculate an estimated value upon reporting the estimated value to the RRH 20. The frequency of the CC may be used by the RRH 20 to calculate a new fading frequency estimated value as described later with reference to FIG. 14.

(Example of Processing in Estimation Result Request-Source)

Next, an example of processing when the RRH 20 which is an estimation result request-source receives the estimation result from the eNB 10 which is the request-destination will be described with reference to FIG. 14.

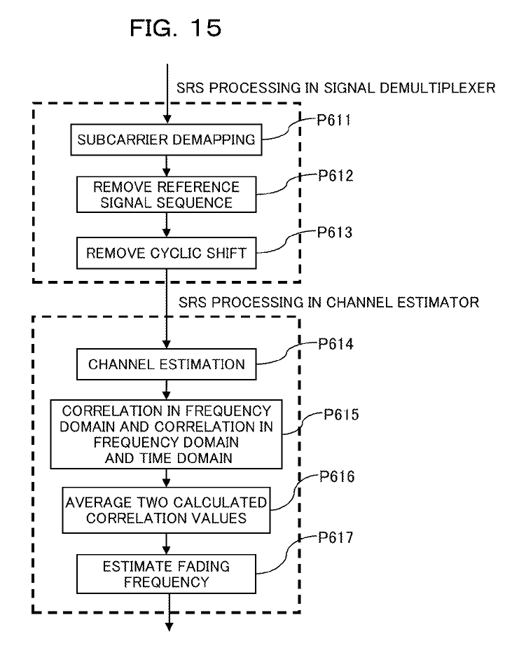

The RRH 20 which is the estimation result request-source calculates a fading frequency estimated value (fd) (processing P61). The fading frequency is estimated as illustrated in FIG. 15. That is, the RRH 20 extracts subcarriers on which a SRS is mapped, from a received signal expanded in the frequency domain by, for example, fast Fourier transform (FFT) processing (subcarrier demapping: processing P611).

Next, the RRH 20 multiplies the demapped signal with a complex conjugate of a reference signal (RS) sequence to obtain a signal in which the RS sequence is cancelled from the received signal (processing P612).

Further, the RRH 20 demultiplexes and extracts a signal for each UE 30 by, for example, canceling a cyclic shift corresponding to eight subcarriers from the signal as described above (processing P613). The above processing P611 to P613 is performed by the signal demultiplexer 523 described later with reference to, for example, FIG. 17.

Next, the RRH 20 calculates a channel estimated value from the signal extracted for each UE 30. For example, the RRH 20 calculates the channel estimated value by averaging the extracted signals every eight subcarriers (processing P614).

Subsequently, the RRH 20 calculates a correlation value in the frequency domain from the calculated channel estimated value, and calculates a correlation value between the frequency domain and the time domain (a correlation between the SRS and a previous SRS) (processing P615). Further, the RRH 20 averages the two calculated correlated values (processing P616), calculates a power ratio from the two averaged correlated value and calculates a fading frequency estimated value from this calculated value (processing P617). The above processing P614 to P617 is performed by a channel estimator 525 described later with reference to FIG. 17, for example. The obtained estimated value is used for scheduling performed by a scheduler 126 described later with reference to FIG. 17, for example.

Turning back to FIG. 14, the RRH 20 determines whether or not the RRH 20 has requested a fading frequency estimation result to the eNB 10 after calculating the fading frequency estimated value as described above (processing P62). As a result of the determination, upon not requesting the estimation result (No in processing P62), the RRH 20 performs transceiving control processing (for example, scheduling of radio resources) for the UE 30 by using the calculated estimated value by the scheduler 126 (processing P66).

Meanwhile, when requesting the fading frequency estimation result to the eNB 10 (Yes in processing P62), the RRH 20 monitors whether or not the estimation result is obtained (No route in processing P63) until the estimation result is obtained from the request-destination eNB 10 (until it is determined as Yes in processing P63).

Upon receiving the estimation result from the eNB (Yes in processing P63), the RRH 20 calculates a new fading frequency estimated value (fd) based on the obtained estimation result (processing P64). For example, as expressed by following expression (2), the new fading frequency estimated value fd of the request-source is calculated by multiplying a fading frequency estimated value fd′ obtained from the request-destination, with a value obtained by dividing a frequency fc1 of a known request-source CC by a frequency fc2 of a request-destination CC.

fd=(fc1/fc2)×fd′ (2)

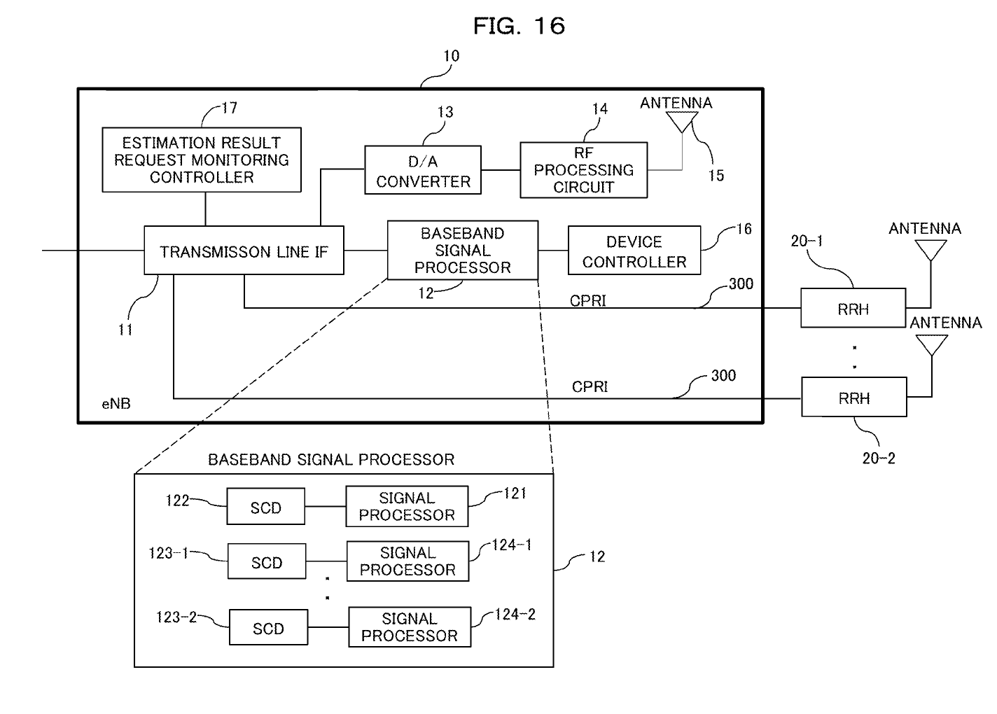

The frequency fc2 of the request-destination CC can be obtained together with the estimated value fd′ obtained from the request-destination eNB 10. However, the RRH 20 does not need a notification of the frequency fc2 from the request-destination eNB 10 when the frequency fc2 of the request-destination CC is known. For example, when an estimation result request monitoring controller 17 is provided to a scheduler (SCD) 122 as described later with reference to FIG. 16, the frequency fc2 of the request-destination CC is known to the RRH 20.

Upon calculating the new estimated value fd as described above, the RRH 20 replaces the estimated value calculated in processing P61 with the new estimated value fd (processing P65). Further, the RRH 20 performs transceiving control processing (for example, scheduling of radio resources) for the UE 30 based on the replaced estimated value fd (processing P66).

Next, FIG. 16 illustrates a functional block diagram of the eNB 10 which realizes the above processing or function. The eNB 10 illustrated in FIG. 16 includes, for example, a transmission line interface (IF) 11, a baseband signal processor 12, a D/A converter 13, a radio (RF) processing circuit 14, an antenna 15, a device controller 16 and the estimation result request monitoring controller 17.

The transmission line IF (interface circuit) 11 is a connection interface for a core network, a control apparatus which controls radio base stations and other radio base stations, and performs processing such as protocol conversion according to a connected transmission line. An interface which connects radio base stations (eNBs) each other may be referred to as a X2 interface.

The baseband signal processor 12 performs baseband signal processing on a DL transmission signal received from the transmission line IF 11 and a UL received signal received from the UE 30. The baseband signal processor 12 includes, for example, signal processors 121, 124-1 and 124-2 and schedulers (SCDs) 122, 123-1 and 123-2.

The signal processor 121 is in charge of DL and UL signal processing in a Pcell, for example. The signal processors 124-1 and 124-2 are, for example, provided for the RRHs 20-1 and 20-2, respectively, and are in charge of DL and UL signal processing in Scells. Hence, the signal processors 124-1 and 124-2 are, for example, connected to the RRHs 20-1 and 20-2 by the CPRI 300. Further, the signal processors 121, 124-1 and 124-2 are, for example, connected to the transmission path IF 11, and are available to give a signal processing result to the estimation result request monitoring controller 17 through the transmission line IF 11.

The SCDs 123-1 and 123-2 are, for example, provided for the RRHs 20-1 and 20-2, respectively, and are operable to control signal processing in the corresponding signal processors 124-1 and 124-2 in association with the SCD 122. In other words, the SCDs 123-1 and 123-2 control (or schedule) an allocation of radio resources (for example, a CC for the CA transmission) for the DL and the UL in Scells. The SCDs 123-1 and 123-2 may be referred to as secondary SCDs (S-SCDs).

The SCD 122 is, for example, a primary SCD (P-SCD) with respect to the S-SCDs 123-1 and 123-2. The P-SCD 122 is operable to control signal processing in the signal processor 121. In other words, the P-SCD 122 is operable to control (or schedule) an allocation of radio resources (for example, a CC for the CA transmission) for the DL and the UL in the Pcell. Further, the P-SCD 122 is operable to control scheduling performed by the S-SCDs 123-1 and 123-2. Consequently, the P-SCD 122 is available to learn information on the CCs used in both of the Pcell and the Scells.

The D/A converter 13 converts a DL digital signal subjected to signal processing by baseband signal processor 12 into an analog signal, and outputs the analog signal to the RF processing circuit 14. Further, the D/A converter 13 converts the UL analog signal received from the RF processing circuit 14 into a digital signal, and outputs the digital signal to the baseband signal processor 12.

The RF processing circuit 14 is operable to up-convert the DL signal input from the D/A converter 13 to a radio signal, and to output the DL radio signal to the antenna 15. Further, the RF processing circuit 14 is operable to down-convert the UL signal received at the antenna 15, and to output the UL signal to the D/A converter 13.

The antenna 15 emits to a space the DL radio signal input from the RF processing circuit 14, and outputs the UL radio signal received from the space to the RF processing circuit 14. A range of a space in which a radio signal is available to be transceived corresponds to the Pcell.

The device controller 16 controls the entire operation of the eNB 10.

The estimation result request monitoring controller 17 is, for example, connected to the transmission line IF 11, and is available to communicate with each of the signal processors 121, 124-1 and 124-2 and each of the SCDs 122, 123-1 and 123-2 through the transmission line IF 11. Further, the estimation result request monitoring controller 17 is operable to perform the processing illustrated in FIG. 12.

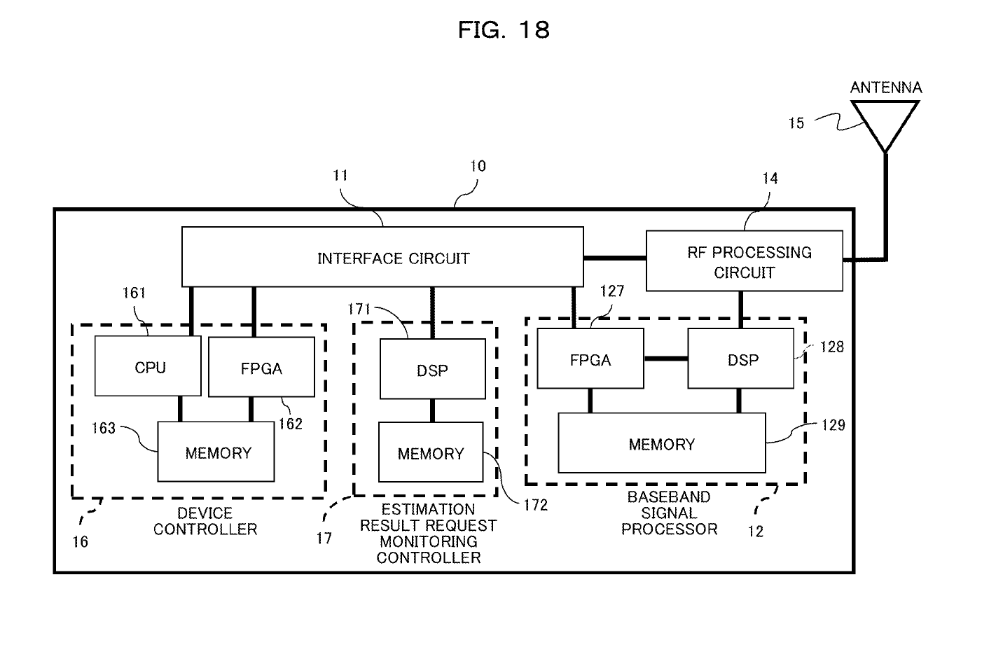

Hence, the estimation result request monitoring controller 17 includes a memory 172 (see FIG. 18) which stores the estimated value management table 173 illustrated in FIG. 13. The estimation result request monitoring controller 17 is operable to register fading frequency estimated values calculated by the signal processors 121, 124-1 and 124-2 in the estimated value management table 173 as illustrated in FIG. 13. In other words, the fading frequency estimated value of each CC scheduled by each of the SCDs 122, 123-1 and 123-2 is managed in the estimated value management table 173. When a CC used for the CA transmission is changed, entries in the estimated value management table 173 are updated in accordance with the change.

Further, the estimation result request monitoring controller 17 is operable to monitor whether or not the above-described fading frequency estimated value request is received from any one of the signal processors 121, 124-1 and 124-2. Upon receiving the request of the estimated value, the estimation result request monitoring controller 17 selects an optimal estimated value referring to the estimated value management table 173, and reports the selected estimated value to the SCD 122, 123-1 or 123-2 which controls the request-source signal processor 121, 124-1 or 124-2. The SCD 122, 123-1 or 123-2 calculates the new estimated value fd by performing the processing illustrated in FIGS. 14 and 15 by using the reported estimated value, and performs scheduling based on the estimated value fd.

For example, it is assumed that the estimation result request monitoring controller 17 receives an estimated value request from one of the signal processors 124-1 and 124-2 in charge of signal processing in the Scell (RRH 20), through the transmission line IF 11. In this case, the estimation result request monitoring controller 17 transmits the report of the estimated value to the SCD 123-1 or 123-2 in charge of scheduling of the Scell through the transmission line IF 11. Consequently, the request-source in this case can be considered as the Scell (RRH 20).

In other words, the estimation result request monitoring controller 17 is available to monitor in which one of radio base stations forming any one of macrocells, femtocells, picocells and microcells a timing deviation is little, and is available to provide to a request-source an estimated value obtained from a radio base station whose timing deviation is relatively small.

A part or all of functions of the estimation result request monitoring controller 17 may be provided as one function of the P-SCD 122, for example. In this case, as described above, the P-SCD 122 is available to learn information on CCs used in both of the Pcell and the Scell. Consequently, P-SCD 122 is available to calculate the new fading frequency estimated value fd illustrated in FIG. 14 and expressed by expression (2) without obtaining information of the CC from an outside apparatus.

Next, FIG. 17 illustrates a functional block diagram of the eNB 10 focusing on the baseband signal processor 12. The baseband signal processor 12 illustrated in FIG. 17 includes, for example, a signal processor 125 and the scheduler 126. The signal processor 125 corresponds to the signal processors 121, 124-1 and 124-2 illustrated in FIG. 16. The scheduler 126 corresponds to the SCDs 122, 123-1 and 123-2 illustrated in FIG. 16.

The D/A converter 13 illustrated in FIG. 16 includes a digital-analog converter (DAC) 131 and an analog-digital converter (ADC) 132 in FIG. 17. Further, the RF processing circuit 14 illustrated in FIG. 16 includes a transmission RF unit 141 and a reception RF unit 142 in FIG. 17.

The DAC 131 converts a transmission DL signal which is a digital signal and is input from the signal processor 125 (a CP inserter 515 described below), into an analog signal, and outputs the analog signal to the transmission unit 141. The “CP” is an abbreviation of a cyclic prefix. The transmission RF unit 141 converts (or up-converts) the transmission DL signal converted into the analog signal by the DAC 131, into a radio signal, and outputs the radio signal to the antenna.

The reception RF unit 142 down-converts the received UL signal received at the antenna from UE 30, and outputs the received UL signal to the ADC 132. The ADC 132 converts the received UL signal which is an analog signal and is input from the reception RF unit 142, into a digital signal, and outputs the digital signal to the signal processor 125 (a CP remover 521 described below).

The signal processor 125 includes an error correction encoder 511, a data modulator 512, a signal multiplexer 513, an IFFT unit 514 and a CP inserter 515 as an example of a transmitter 51.

The error correction encoder 511 adds an error correction code to a transmission data signal. For example, a turbo code can be used for the error correction code.

The data modulator 512 modulates the transmission data signal to which the error correction code is added by using the OFDM scheme to generate an OFDM symbol. The OFDM symbol is subjected to subcarrier modulation by a multi-leveled modulating scheme such as BPSK, QPSK, 16 QAM or 64 QAM.

The signal multiplexer 513 multiplexes the transmission data signal (or the OFDM symbol) modulated by the data modulator 512 and a reference signal (for example, the SRS).

The IFFT unit 514 performs IFFT processing on the output signal from the signal multiplexer 513 to convert the output signal into a time domain signal.

The CP inserter 515 inserts a CP which serves as a guard interval in the output signal of the IFFT unit 514, and outputs the CP inserted signal to the DAC 131.

Meanwhile, the signal processor 125 includes a CP remover 521, an FFT unit 522, a signal demultiplexer 523, a data demodulator 524, a channel estimator 525, a timing detector 526, an IDFT unit 527 and an error correction decoder 528 as an example of a receiver 52. Further, the receiver 52 includes an estimation accuracy deterioration timing detection circuit 529 and an estimation result request control circuit 530.

The CP remover 521 removes a CP inserted in the UL signal received from the ADC 132.

The FFT unit 522 performs FFT processing on the received UL signal after removal of the CP to convert the received UL signal into a frequency domain signal.

The signal demultiplexer 523 performs the above-described subcarrier demapping on the frequency domain signal obtained by the FFT processing. The SRS is canceled by the subcarrier demapping, and a signal extracted and demultiplexed for each UE 30 is input to the data demodulator 524, the channel estimator 525 and the timing detector 526.

The data demodulator 524 demodulates the received data signal demultiplexed by the signal demultiplexer 523 using the OFDM demodulating scheme.

The channel estimator 525 performs the channel estimation described above with reference to FIG. 15. The obtained channel estimated value is used for scheduling performed by the scheduler 126.

As described above with reference to FIGS. 9 and 10, the timing detector 526 detects a timing at which reception power comes to a peak in a delay profile and detects (or calculates) a difference (timing deviation) between the timing and the originally desired reference timing. This processing corresponds to processing P41 in FIG. 9. The detected timing deviation is given to the scheduler 126 as an information element of a TA command as described above.

The IDFT unit 527 performs an inverse discrete Fourier transform (IDFT) on the received data signal demodulated by the data demodulator 524 to convert the received data signal into a time domain signal.

The error correction decoder 528 corrects an error of an input signal using the error correction code included in the input signal from the IDFT unit 527 tp obtain the received data signal. The obtained received data signal is output to, for example, the transmission line IF 11. The error correction decoder 528 is operable to output information such as ACK/NACK or CQI to the scheduler 126 as an example of a reception processing result according to the error correction result.

The ACK and the NACK are information indicating reception success and reception failure, respectively, and, upon receiving the NACK, the scheduler 126 controls a retransmission of data which fails to be received. Further, the CQI (Channel Quality Indicator) is an example of information indicating channel quality with respect to the UE 30, and is information measured in the UE 30. The scheduler 126 is operable to control scheduling for the DL based on the CQI.

The estimation accuracy deterioration timing detection circuit 529 detects a timing deviation from the reference timing by performing processing P41 illustrated in FIG. 9.

The estimation result request control circuit 530 transmits, for example, an estimated value request to the estimation result request monitoring controller 17 through the transmission line IF 11 by performing processing P42 to P47 illustrated in FIG. 9 based on the timing deviation detected by the estimation accuracy deterioration timing detection circuit 529.

The estimation accuracy deterioration timing detection circuit 529 and the estimation result request control circuit 530 may be provided in the RRH 20. The RRH 20 may alternatively correspond to a radio base station which forms a small cell such as a femtocell, a picocell or a microcell.

The estimation result request monitoring controller illustrated in FIG. 16 and the estimation accuracy deterioration timing detection circuit 529 and the estimation result request control circuit 530 illustrated in FIG. 17 may form an example of a controller. The controller is operable to control an allocation of radio resources in one of Pcell and the Scell in which a fading frequency estimated value with a relatively low estimation accuracy is obtained, based on a fading frequency estimated value with a relatively high estimation accuracy among the fading frequency estimated values obtained from a radio signal sent by the UE 30 and received in the Pcell and the Scell.

Next, FIG. 18 illustrates an example of a hardware configuration of the eNB 10 which realizes the functional block described above with reference to FIGS. 16 and 17.

As illustrated in FIG. 18, the device controller 16 illustrated in FIG. 16 can be realized by using, for example, a CPU 161, an FPGA 162 and a memory 163. Further, the estimation result request monitoring controller 17 illustrated in FIG. 16 can be realized by using, for example, a DSP 171 and a memory 172. Furthermore, the baseband signal processor 12 illustrated in FIGS. 16 and 17 can be realized by using, for example, an FPGA 127, a DSP 128 and a memory 129. The CPU, the FPGA and the DSP are examples of a computation processing device with computation capability.

### First Modified Example

The above embodiment explains the case where a timing deviation occurs in accordance with a movement of a UE 30 and a fading frequency estimation accuracy deteriorates. However, there is also a case where a timing deviation occurs even when the UE 30 is not moving. For example, there is a case where an accuracy of a clock circuit which determines a reference timing differs between a macrocell 100 and a small cell 200.

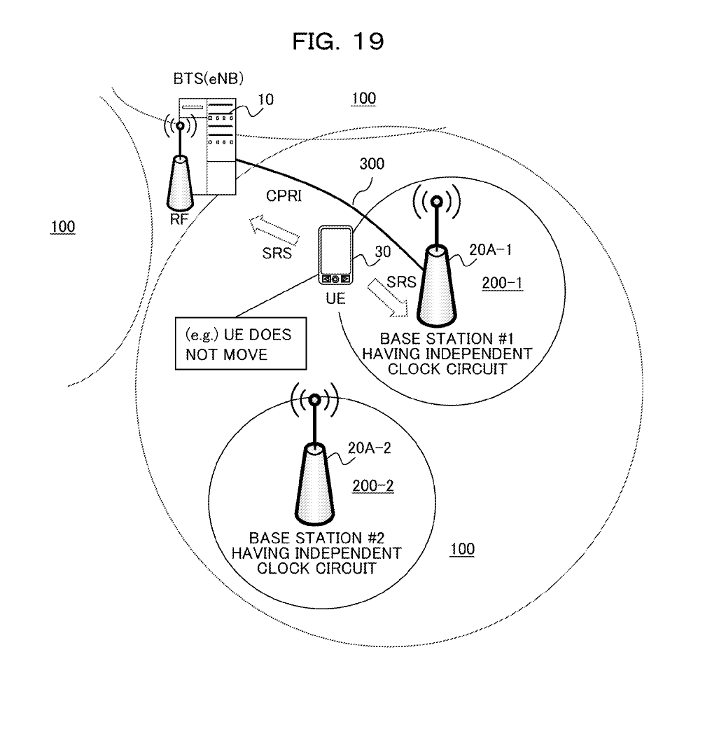

For example, as illustrated in FIG. 19, there is a case where specifications of clock circuits installed in radio base stations 20A-1 and 20A-2 which form Scells 200-1 and 200-2 are poorer and less accurate than a clock circuit installed in an eNB 10 which forms the Pcell 100. The radio base stations 20A-1 and 20A-2 may be base stations which form femtocells, picocells or microcells or may be RRHs.

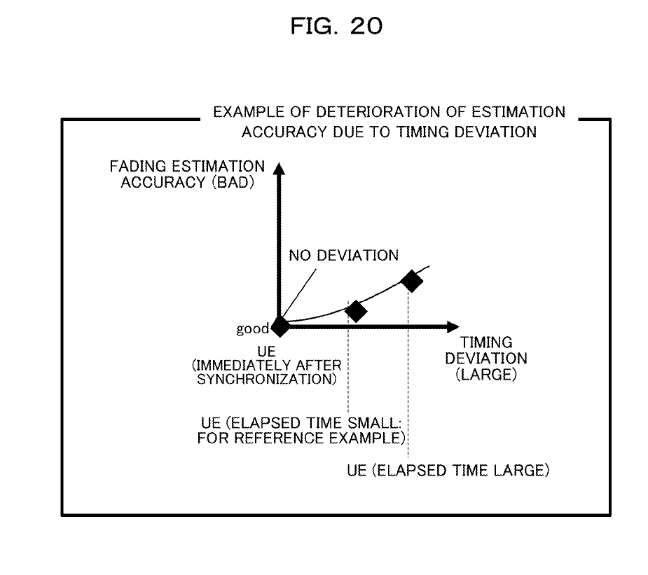

In this case, in the UE 30 which is available to access both of the eNB 10 and the radio base station 20A-1, a timing deviation may occur due to a difference of the clock accuracy before establishment of resynchronization as time passes even when the UE 30 does not move after establishing synchronization with the eNB 10 and the radio base station 20A-1 (see, for example, FIG. 20). When the timing deviation is occurred, a fading frequency estimation accuracy may deteriorate, and therefore, a UL reception throughput may also deteriorate as described previously.

Even in such a case, similar to the above-described embodiment, for example, the radio base station 20A-1 is operable to obtain and use a fading frequency estimated value from the eNB 10 which is supposed to obtain a relatively good estimation accuracy. Consequently, it is possible to prevent deterioration of the reception throughput.

In some cases, a turbo code is used for a PUSCH which is an example of a data channel, and a turbo code is not used for an SRS. In this case, a reception quality of the SRS may deteriorate compared to the PUSCH having higher error correction capability than that of the SRS. Even in such a case, by obtaining and using a fading frequency estimated value from a radio base station in which an estimation accuracy is relatively good, it is possible to prevent deterioration of a reception throughput.

### Second Modified Example

In the above-described embodiment, a fading frequency estimated value is requested to a Pcell in response to a detection of a timing deviation which influences a fading frequency estimation accuracy in a Scell. However, for example, estimated values may be periodically provided from the Pcell to the Scell.

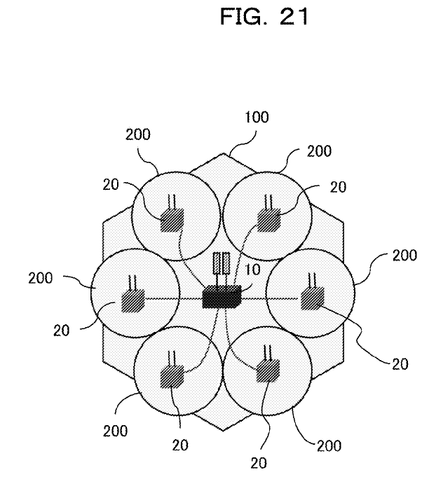

For example, as illustrated in FIG. 21, it is useful in a case where “Coordinated multi-point” is assumed by “Heterogeneous deployment” in “Scenario 3” and “Scenario 4” disclosed in, for example, “3GPP 36.818 v11.2.0 5.1.2 CoMP scenarios”. FIG. 21 illustrates that six Scells 200 formed by six RRHs 20 are provided in a Pcell 100 formed by an eNB 10 with an overlay arrangement. The eNB 10 and each RRH 20 are, for example, connected using optical fibers to communicate with each other.

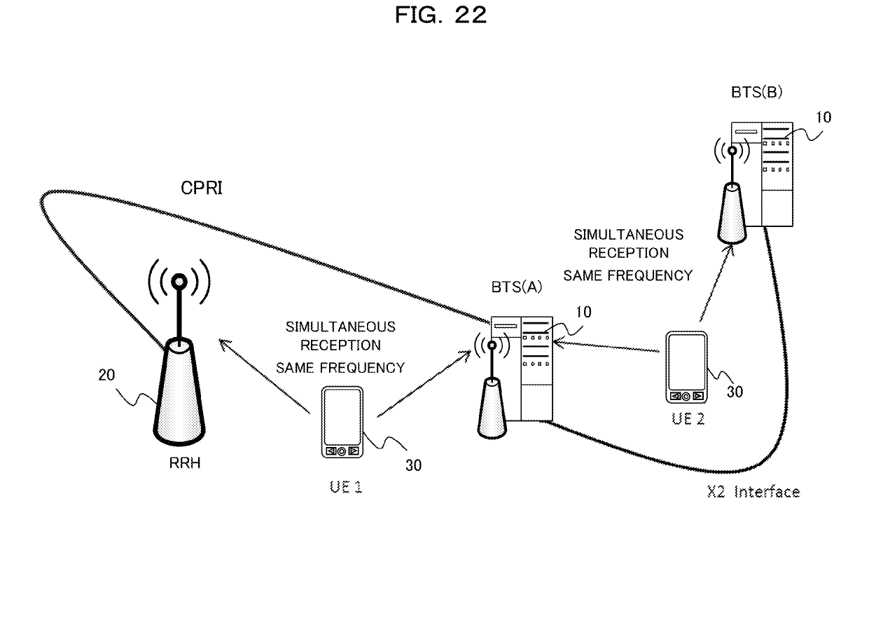

Specifically, this is a case which assumes the “joint reception (JR)” disclosed in, for example, “3GPP 36.818 v11.2.0 Chapter 6”. In this case, as illustrated in FIG. 22, for example, the UE 30 is available to simultaneously access multiple points (for example, the eNB 10 and the RRH 20 or the two eNBs 10), and frequencies of signals received at the multiple points are the same.

In such a case, a fading frequency estimated value obtained from another cell may be used as it is without calculating a new fading frequency estimated value as illustrated in FIG. 14. Consequently, it is possible to achieve the same effect or advantage as that of the above-described embodiment by periodically providing an estimated value from a cell in which a relatively high fading frequency estimation accuracy is obtained to a cell in which a relatively low fading frequency estimation accuracy is obtained (for example, from the Pcell to the Scell or from the Scell to the Pcell). For example, the X2 interface may be used upon transceiving an estimated value between the eNBs 10.

According to the above technology, it is possible to prevent a communication quality between radio base stations and radio terminals from decreasing due to a deterioration of a fading frequency estimation accuracy.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment(s) of the present invention have been described in detail, it should be understood that the various changes, substitutions, and alterations could be made hereto without departing from the spirit and scope of the invention.

What is claimed is:

1. A radio base station configured to process a radio signal received from a radio terminal configured to perform a communication using radio resources of a first radio area and a second radio area, the radio base station comprising
a controller configured to control an allocation of a radio resource in one of the first and second radio areas in which a fading frequency estimated value with a relatively low estimation accuracy is obtained, based on a fading frequency estimated value with a relatively high estimation accuracy among the fading frequency estimated values obtained from a radio signal sent by the radio terminal and received in the first and second radio areas.

2. The radio base station according to claim 1, wherein, upon detecting that the fading frequency estimation accuracy in one of the first and second radio areas deteriorates a predetermined value or more, the controller controls the allocation of the radio resource in one of the first and second radio areas based on the fading frequency estimated value in the other one of the first and second radio areas.

3. The radio base station according to claim 2, wherein, upon detecting that a reception timing of a reference signal included in the radio signal deviates a predetermined value or more from a predetermined reference timing, the controller determines that the estimation accuracy deteriorates.

4. The radio base station according to claim 1, wherein the radio signal received from the radio terminal is transmitted using a carrier aggregation, CA.

5. The radio base station according to claim 4, wherein the controller manages the fading frequency estimated values for each component carrier in the CA transmission and selects an optimal fading frequency estimated value to control the allocation of the radio resource.

6. A radio communication system comprising:
a radio terminal configured to perform a communication using radio resources of a first radio area and a second radio area; and
a radio base station configured to control an allocation of a radio resource in one of the first and second radio areas in which a fading frequency estimated value with a relatively low estimation accuracy is obtained, based on a fading frequency estimated value with a relatively high estimation accuracy among the fading frequency estimated values obtained from a radio signal sent by the radio terminal and received in the first and second radio areas.
